(19) United States
(12) Patent Application Publication
(10) Pub. No.: US 2013/0204476 A1
(43) Pub. Date: Aug. 8, 2013

(54) METHOD AND DEVICE FOR REGENERATING A PARTICLE FILTER PRESENT IN A HYBRID DRIVE

(71) Applicant: Robert Bosch GmbH, Stuttgart (DE)

(72) Inventors: Oliver Zink, Muggensturm (DE); Wolfgang Bartusch, Leonberg (DE)

(73) Assignee: ROBERT BOSCH GMBH, Stuttgart (DE)

(21) Appl. No.: 13/759,140

(22) Filed: Feb. 5, 2013

(30) Foreign Application Priority Data
Feb. 7, 2012 (DE) 102012201765.8
Jan. 21, 2013 (DE) 102013200856.2

(51) Int. Cl. B60W 20/00; B60W 10/08; B60W 10/06

(52) U.S. Cl. CPC B60W 20/108; B60W 10/06; B60W 10/08; B60W 2600/00; Y10S 903/93
USPC 701/22; 180/65.265; 903/930

(57) ABSTRACT

A method for regenerating a particle filter (28). The procedure according to the invention is characterized in that before the regeneration of the particle filter (28), the battery (16) is discharged to a minimum state of charge by increasing the torque portion (20) which the electric motor (14) contributes to the total torque (24), in that when the minimum state of charge of the battery (16) is reached the regeneration of the particle filter (28) is initiated by virtue of the fact that an operating range (36.1, 36.2, 36.3, 36.4, 38.1, 38.2, 38.3, 40) which brings about an increase in the exhaust gas temperature is determined in an engine load characteristic diagram (30) of the internal combustion engine (12), and in that at least when the regeneration of the particle filter (28) is initiated, the internal combustion engine (12) is operated in this selected operating range.

### BACKGROUND OF THE INVENTION

The invention relates to a method for regenerating at least one particle filter which is arranged in the exhaust duct of an internal combustion engine of a hybrid drive. The hybrid drive contains at least one electric motor in addition to the internal combustion engine. The electrical energy for operating the electric motor is made available by a chargeable battery. The electric motor is used, on the one hand, for the drive and, on the other hand, as a generator for charging the battery.

The invention also relates to a hybrid coordinator for actuating the hybrid drive. The hybrid coordinator coordinates the torque which is to be applied by the internal combustion engine and by the electric motor. The hybrid coordinator also coordinates the charging process of a battery. The hybrid coordinator furthermore coordinates, in particular, the regeneration of the particle filter.

In the case of the hybrid drive, an internal combustion engine and at least one electric motor are used. The entire torque is made available proportionally by the internal combustion engine and by the electric motor. In this context, depending on the total torque requirement or the requirement in terms of the charging of the battery, the entire torque can be made available solely by the internal combustion engine, solely by the electric motor or proportionally by both machines.

The electric motor can be operated to charge the battery as a generator. In this case, the generator is driven by the internal combustion engine or it converts kinetic energy made available under certain circumstances into electrical energy.

In laid-open patent application DE 10 2007 008 745 A1, a control unit of a hybrid vehicle is described which defines the torque contributions of a diesel engine and of an electric motor. A particle filter is arranged in the exhaust duct of the diesel engine. The control unit operates the diesel engine alone when the required total torque can be made available by the diesel engine. The control unit operates both the diesel engine and the electric motor when the diesel engine alone cannot make available the required torque, wherein the additionally necessary torque is made available by the electric motor. When regeneration of the particle filter is necessary, the control unit operates the diesel engine in such a way that at low rotational speed of the diesel engine that portion of the total torque which is made available by the diesel engine is increased. As a result, when the load of the hybrid drive is low the exhaust gas temperature is also increased to such an extent that owing to the increased exhaust gas temperature a regeneration of the particle filter can be initiated more efficiently in terms of energy. Furthermore there is provision that the control unit defines that portion of the total torque which is to be made available by the diesel engine, while taking into account the state of charge of a battery, with the result that the state of charge of the battery can be kept in a predefined range.

Laid-open patent application JP 2005-120887 A has described a hybrid drive which contains a diesel engine and an electric motor, wherein a particle filter is arranged in the exhaust duct of the diesel engine. In order to initiate the regeneration of the particle filter, at low rotational speeds of the diesel engine the torque contribution which is to be applied by the diesel engine is increased in order to increase the exhaust gas temperature.

In laid-open patent application JP 2006-275009 A a controller is described for a hybrid vehicle which contains a diesel engine in whose exhaust duct a particle filter is arranged. The controller is configured in such a way that the torque which is to be made available by the diesel engine is increased during the regeneration of the particle filter, and the torque contribution of the electric motor is reduced.

In the known hybrid drives, the energy which is additionally made available by the diesel engine during the regeneration of the particle filter cannot be used to charge the battery if the battery is already charged.

### SUMMARY OF THE INVENTION

The object of the invention is therefore to specify a method which permits energy-saving regeneration of particle filters which are arranged in the exhaust duct of an internal combustion engine, wherein the internal combustion engine is provided in a hybrid drive together with at least one electric motor.

The object of the invention is also to make available a hybrid coordinator for carrying out the method.

The invention is based on a method for regenerating a particle filter which is arranged in the exhaust duct of an internal combustion engine, wherein the internal combustion engine is part of a hybrid drive which additionally contains at least one electric motor in which the electrical energy for the electric motor is made available by a chargeable battery, in which the electric motor is temporarily operated as a generator for charging the battery, in which a total torque which is to be applied by the hybrid drive is made available by the internal combustion engine and/or by the electric motor, and in which in order to regenerate the particle filter shifting of the load point of the internal combustion engine is carried out which leads to an increase in the exhaust gas temperature.

The procedure according to the invention is characterized in that before the regeneration of the particle filter, the battery is discharged to a minimum state of charge by increasing the torque portion which the electric motor contributes to the total torque, in that when the minimum state of charge of the battery is reached the regeneration of the particle filter is initiated by virtue of the fact that an operating range which brings about an increase in the exhaust gas temperature is determined in an engine load characteristic diagram of the internal combustion engine, and in that at least when the regeneration of the particle filter is initiated, the internal combustion engine is operated in this selected operating range.

In particular in the case of low-load operating phases of the hybrid drive, the procedure according to the invention makes it possible to reduce the regeneration duration and the fuel consumption.

The hybrid coordinator according to the invention for regenerating a particle filter which is arranged in the exhaust duct an internal combustion engine contains an engine load characteristic diagram for defining suitable operating conditions, in particular for initiating the regeneration of the particle filter. The hybrid coordinator according to the invention is therefore specifically configured to carry out the method according to the invention.

### BRIEF DESCRIPTION OF THE DRAWINGS

FIG. 1 is a technical environment in which a method according to the invention for regenerating a particle filter runs, and

FIG. 2 shows an engine load characteristic diagram in the form of a factor diagram.

### DETAILED DESCRIPTION

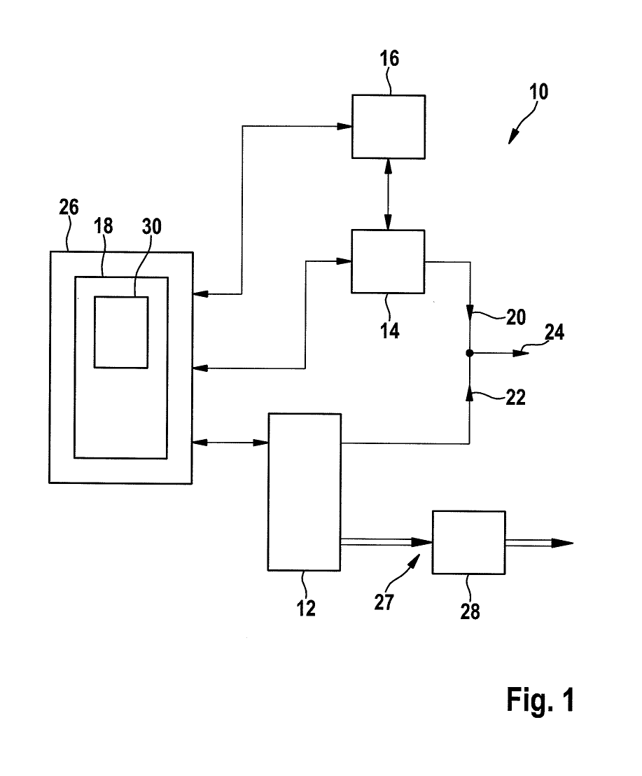

FIG. 1 shows a hybrid drive 10 in which an internal combustion engine 12 and at least one electric motor 14 are provided as drives. The internal combustion engine 12 may be a petrol internal combustion engine, a diesel internal combustion engine, a gas internal combustion engine or some other fuel mixture internal combustion engine. The energy for operating the electric motor 14 is made available by a chargeable battery 16.

In order to control the hybrid drive 10, a hybrid coordinator 18 is provided which coordinates both the torque contribution 20 of the electric motor 14 and the torque contribution 22 of the internal combustion engine 12 to the entire torque 24. Furthermore, the hybrid coordinator 18 controls the charging and the discharging of the battery 16. The hybrid coordinator 18 is an integral component of a superordinate engine controller 26.

A particle filter 28 is arranged in the exhaust duct 27 of the internal combustion engine 12. The particle filter 28 is regenerated as a function of the particle filling level. The particles which are collected by the particle filter 28 can be burnt, in particular if they are soot particles, within the scope of the regeneration. Without further measures such as, for example, conditioning of the particles through fuel additives, it is possible to expect a spontaneous oxidation reaction starting from a temperature of approximately 650 degrees Celsius. If the internal combustion engine 12 is operated with a large load, the exhaust gas temperature in the exhaust duct 27 can reach the 650 degrees Celsius which is necessary to initiate the regeneration. If the internal combustion engine 12 is a petrol internal combustion engine, given a high load it is possible to expect an exhaust gas temperature of a high level which is, however, reached rather rarely with a diesel internal combustion engine.

However, given a low load of the internal combustion engine 12, a sufficiently high exhaust gas temperature cannot be assumed either with a diesel internal combustion engine or with a petrol internal combustion engine. One possible way of increasing the exhaust gas temperature is to increase the load of the internal combustion engine 12. In this context, the combustion conditions can be worsened, with the result that given the same torque portion 22 of the internal combustion engine 12 the exhaust gas temperature rises. In the case of a diesel internal combustion engine, the time of the different fuel injections can be changed. In the case of a petrol internal combustion engine, it is possible, in particular, to intervene in the ignition time.

The exhaust gas temperature does not necessarily have to be raised to 650 degrees Celsius for efficient regeneration of the particle filter 28 or at least for the initiation of the regeneration. The efficiency is already increased if the exhaust gas temperature is raised at all in which case further measures for increasing the temperature then have to be provided in the particle filter, these being, for example, introducing fuel into the exhaust duct 17 which burns in a catalytically supported fashion and in this way further increases the exhaust gas temperature or directly heats the particle filter.

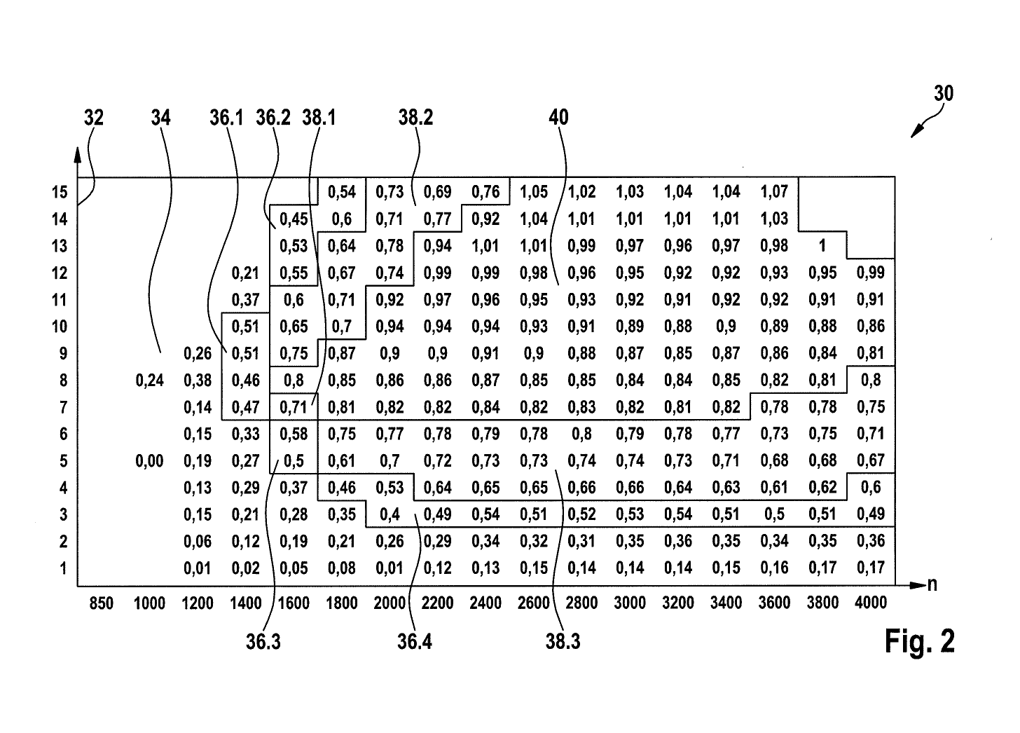

FIG. 2 shows an engine load characteristic diagram 30 of the internal combustion engine 12 in the form of a factor diagram. Whether and how effectively regeneration of the particle filter 28 can be carried out is reflected by the factors entered by way of example in the engine load characteristic diagram 30. In the engine load characteristic diagram 30, each pair of values of the load 32 and rotational speed n is assigned such an influencing factor. The factors specify the efficiency of the regeneration process standardized to the numerical value 1. The factors depend on the load 32 of the internal combustion engine 12 and on the rotational speed n. The engine load characteristic diagram 30 is divided into nine operating ranges 34, 36.1, 36.2, 36.3, 36.4, 38.1, 38.2, 38.3, 40.

The first operating range 34 indicates operating conditions which do not reveal any suitable exhaust gas conditions for regeneration of the particle filter 28. The first operating range 34 corresponds to a low load range. The second operating range 36.1, the third operating range 36.2, the fourth operating range 36.3 and the fifth operating range 36.4 show factors which permit regeneration at an average efficiency. In the sixth operating range 38.1, seventh operating range 38.2 and in the eighth operating range 38.3, good efficiency is achieved, and in the ninth operating range 40 optimum efficiency is achieved, during the regeneration of the particle filter 28.

The factors entered by way of example into the engine load characteristic diagram 30 depend, in particular, on the fuel consumption of the internal combustion engine 12, the temperature in the particle filter 28 and the oxygen mass flow upstream of the particle filter 28 at the specific load 32 and the specific rotational speed n.

The hybrid coordinator 18 controls the torque portion 22 of the internal combustion engine 12 and the torque portion 20 of the electric motor 14 in order to make available the entire torque 24 which is to be applied by the hybrid drive 10.

In order to carry out effective regeneration of the particle filter 28 or at least for effective initiation of the regeneration of the particle filter 28 raising of the load 32 is required for most load points of the internal combustion engine 12 in order to reach one of the suitable ranges, for example the ninth operating range 40.

According to the invention, the hybrid coordinator 18 makes available the regeneration of the particle filter 28 by virtue of the fact that the battery 16 is firstly discharged to a minimum state of charge. In this operating state, the portion 20 of the entire torque 24 to be made available by the hybrid drive 10 which is to be made available by the electric motor 14 is preferably increased to the maximum possible absolute value.

The minimum state of charge may depend, for example, on the age of the battery 16 and on the temperature of the battery 16.

The discharging of the battery 16 takes place as a result of negative shifting of the load point or as a result of shutting down of the internal combustion engine 12 if a purely electric mode is possible. In order to make the discharging of the battery 16 as effective as possible, the ineffective low load range of the internal combustion engine 12 should be avoided.

The hybrid coordinator 18 ends the discharging process of the battery 16 when the permissible minimum state of charge is reached.

If the battery 16 has reached the minimum state of charge, the hybrid coordinator 18 can enable the regeneration of the particle filter 28. Since the battery 16 is now at the lower end of the permissible state of charge, the internal combustion engine 12 can be operated with relatively large loads 32. It is essential here that the energy or the excess torque not required to make available the torque portion 22 of the internal combustion engine 12 can be used to drive the electric motor 14 in the generator mode and to recharge the battery 16.

The necessary information about the combustion application of the particle filter regeneration is stored in the hybrid coordinator 18. The hybrid coordinator 18 determines, from the stored engine load characteristic diagram 30, the operating ranges 36.1, 36.2, 36.3, 36.4, 38.1, 38.2, 38.3, 40, in which suitable operating conditions are present for regeneration of the particle filter 28. The hybrid coordinator 18 calculates a load point shift and/or a rotational speed shift which are/is suitable for the entire torque 24 to be applied and which improve/improves the conditions for the particle filter regeneration.

A rotational speed shift requires a suitable gear mechanism here.

The hybrid coordinator 18 takes into account the available charging capacity in the load point shift or rotational speed shift until the maximum state of charge of the battery 16 is reached.

The low load range, in particular the first operating range 34, and as far as possible also the second, third, fourth and fifth operating ranges 36.1, 36.2, 36.3 and 36.4, in which only a low operating temperature and a small oxygen mass flow can be expected, are avoided by the hybrid coordinator 18 for as long as is permitted by the state of charge of the battery 16.

In the low-oxygen operating range of the engine load characteristic diagram 30 at low rotational speeds n and near to the full load, the burning-off speed of the particles drops. In this operating range of the engine load characteristic diagram 30, the hybrid coordinator 18 performs a reduction in the load point of the internal combustion engine 12 and, if possible, an increase in the rotational speed n. This is done by the electric motor 14 generating part of the required total torque 24, associated with a reduction in the state of charge of the battery 16.

In the other operating ranges of the engine load characteristic diagram 30, the hybrid coordinator 18 raises the load point. The scope of the raising of the load point is determined by the increase in efficiency of the particle filter regeneration which can be achieved by means of this measure. The increase in efficiency can be read out directly from the engine load characteristic diagram 30 on the basis of the factors.

If the hybrid drive 10 is arranged in a motor vehicle, overrun situations can occur in which the motor vehicle remains in motion without drive. In such an overrun phase the torque portion 22 of the internal combustion engine 12 can be set to zero, and the internal combustion engine 12 can be shut down. The kinetic energy which is made available by the drive (not shown here in more detail) in the overrun phase, and which can be considered to be a negative total torque 24, can be used to operate the electric motor 14 in the generator mode, in order to charge the battery 16.

During running regeneration of the particle filter 28, the hybrid coordinator 18 prevents this procedure in order to hold in reserve the possibly still available charge capacity of the battery 16 for the raising of the load point and/or increasing of the rotational speed. With this measure, an interruption in the regeneration process and correspondingly necessary inefficient part regeneration processes of the particle filter 28 in the case of a stationary state of the internal combustion engine 12 can be avoided.

1. A method for regenerating a particle filter (28) which is arranged in the exhaust duct (27) of an internal combustion engine (12), wherein the internal combustion engine (12) is part of a hybrid drive (10) which additionally contains at least one electric motor (14) in which the electrical energy for the electric motor (14) is made available by a chargeable battery (16), in which the electric motor (14) is temporarily operated as a generator for charging the battery (16), in which a total torque (24) which is to be applied by the hybrid drive (10) is made available, and in which in order to regenerate the particle filter (28) shifting of the load point of the internal combustion engine (12) is carried out which leads to an increase in the exhaust gas temperature, characterized in that, before the regeneration of the particle filter (28), the battery (16) is discharged to a minimum state of charge by increasing the torque portion (20) which the electric motor (14) contributes to the total torque (24), in that when the minimum state of charge of the battery (16) is reached the regeneration of the particle filter (28) is initiated by virtue of the fact that an operating range (36.1, 36.2, 36.3, 36.4, 38.1, 38.2, 38.3, 40) which brings about an increase in the exhaust gas temperature is determined in an engine load characteristic diagram (30) of the internal combustion engine (12), and in that at least when the regeneration of the particle filter (12) is initiated, the internal combustion engine (12) is operated in this selected operating range (36.1, 36.2, 36.3, 36.4, 38.1, 38.2, 38.3, 40).

2. The method according to claim 1, characterized in that the total torque (24) is made available by the internal combustion engine (12) and by the electric motor (14).

3. The method according to claim 1, characterized in that the total torque (24) is made available by the internal combustion engine (12).

4. The method according to claim 1, characterized in that the total torque (24) is made available by the electric motor (14).

5. The method according to claim 1, characterized in that during the regeneration of the particle filter (28), the internal combustion engine (12) is operated in the selected operating range (36.1, 36.2, 36.3, 36.4, 38.1, 38.2, 38.3, 40).

6. The method according to claim 1, characterized in that the discharging of the battery (16) takes place by means of a change in load of the internal combustion engine (12) to a smaller load (32).

7. The method according to claim 1, characterized in that the discharging of the battery (16) is carried out by switching off the internal combustion engine (12) and exclusively operating the electric motor (14) in the generator mode.

8. The method according to claim 1, characterized in that during the discharging of the battery (16) operation of the internal combustion engine (12) in the low load range (34) is avoided, and in that the discharging process of the battery (16) is chronologically limited.

9. The method according to claim 1, characterized in that during the discharging of the battery (16) operation of the internal combustion engine (12) in the low load range (34) is avoided.

10. The method according to claim 1, characterized in that the discharging process of the battery (16) is chronologically limited.

11. The method according to claim 1, characterized in that starting from a low rotational speed (n) and a high load (32) of the internal combustion engine (12) during the regeneration of the particle filter (28) the load is reduced and the rotational speed is increased.

12. The method according to claim 1, characterized in that starting from a low rotational speed (n) and a high load (32) of the internal combustion engine (12) during the regeneration of the particle filter (28) the load is reduced.

13. The method according to claim 1, characterized in that starting from a low rotational speed (n) and a high load (32) of the internal combustion engine (12) during the regeneration of the particle filter (28) the rotational speed is increased.

14. The method according to claim 1, characterized in that during the regeneration of the particle filter (28), starting from low rotational speeds (n) and a low load (32) of the internal combustion engine (12) a change in load to a relatively high load takes place and the rotational speed is increased, and in that a change to a relatively high load takes place over all the rotational speed ranges starting from a low load (32).

15. The method according to claim 1, characterized in that during the regeneration of the particle filter (28), starting from low rotational speeds (n) and a low load (32) of the internal combustion engine (12) a change in load to a relatively high load takes place, and in that a change to a relatively high load takes place over all the rotational speed ranges starting from a low load (32).

16. The method according to claim 1, characterized in that during the regeneration of the particle filter (28), starting from low rotational speeds (n) and a low load (32) of the internal combustion engine (12) the rotational speed is increased, and in that a change to a relatively high load takes place over all the rotational speed ranges starting from a low load (32).

17. The method according to claim 1, characterized in that when a load of the internal combustion engine (12) is increased the electric motor (14) is operated as a generator.

18. The method according to claim 1, characterized in that despite a possible overrun mode of the internal combustion engine (12) in which the fuel supply is interrupted, the internal combustion engine (12) continues to be operated by a supply of fuel, and in that the energy which is made available by the internal combustion engine (12) is made available to the electric motor (14), operated as a generator, in order to charge the battery (16).

19. A hybrid coordinator for regenerating a particle filter (28) which is arranged in the exhaust duct (27) of an internal combustion engine (12), characterized in that the hybrid coordinator (18) contains an engine load characteristic diagram (30) and is configured to control the internal combustion engine (12) and the electric motor (14) in order to carry out the method according to claim 1.

20. The hybrid coordinator according to claim 19, characterized in that the hybrid coordinator (18) is a component of a superordinate engine controller (26).
